(19) United States
(12) Patent Application Publication
(10) Pub. No.: US 2011/0298202 A1
(43) Pub. Date: Dec. 8, 2011

(54) Sheets formatted for use in binding machines

(76) Inventor: Harold P. Hocking, Manhattan Beach, CA (US)

(21) Appl. No.: 12/802,414

(22) Filed: Jun. 7, 2010

(51) Int. Cl. B42D 1/00; B42C 19/00

(52) U.S. Cl. 281/15.1; 412/1

(57) ABSTRACT

Sheets for use in a binding apparatus, the sheets being conditioned by removing the outer layer of the sheet on one or both surfaces along the sheet edge that will be bound.

### BACKGROUND OF THE INVENTION

1. Field of the Invention

The present invention is directed to sheets that have been formatted for use with a binding machine.

2. Description of the Prior Art

Typically papers used to print high resolution digital photos used as pages in a photo album or photo book are coated with materials and coatings to enhance the detail of these pictures. These materials and coatings consist of clay or silicate solutions that are proprietary to the paper manufacturing companies. Although the coatings, while enhancing the surface to be printed on, make it difficult for adhesives to adhere to the surface thus creating a problem when binding the edge of the paper using thermal activated adhesives. As a result, these sheets are typically not bound in the conventional method of bookbinding. In order to bind these sheets, they are typically stapled or crimped together prior to applying a cover to the book or photo-book. Other methods have been employed for conditioning the sheets prior to thermally binding the book block together. These methods include splitting the edges of the sheets or roughing the edges of the sheets after printing and prior to binding allowing the adhesive to enter and bond to the internal fibers of the sheets.

In addition to the difficulty with the coatings on the surface of the sheets hampering the adhesion during the thermal bookbinding process as noted hereinabove, the sheets are typically thicker than normal 20-pound bond, 4-mil thick paper sheet. The added thickness from 4-mils to 10- to 12-mils, while enhancing the feel of the photo-book page, creates some other difficulties with regard to bookbinding. Thicker sheets create stress on the thermally bound edge of the sheet when the sheets are spread open. In addition the sheets are not as flexible and do not tend to lay flat when the book is opened.

U.S. Pat. No. 7,677,855 discloses a method for splitting a sheet of paper to expose the inner fibers of the sheet to adhesive and increasing the effective contact surface area to improve binding strength.

Although the prior art discloses various techniques to increase sheet binding strength, the sheet edge typically requires additional processing after printing with the attendant increase in costs. What is desired is to provide sheets for use in a bookbinding apparatus which are more flexible and adhesive receptive than those currently available.

### SUMMARY OF THE INVENTION

The present invention provides sheets that have preconditioned edges, the sheets being used to create photo-book pages prior to printing. Preconditioning of the sheets involves a process that removes the outer layers of the sheet along the edge that will ultimately be bound using traditional thermal bookbinding techniques.

By grinding or abrading off undesirable coatings from the top layer on one or both sides of the sheet to a depth of approximately 2- to 3-mils along the spine edge of the sheets to be bound enhances the bind quality by allowing the adhesive to flow around the sheet edges during the bookbinding process. Rather than relying on the adhesive to bond only to the edge of the sheet, the surface area for adhesion is greatly increased.

Another advantage to the preconditioning process described hereinabove is that the thickness of the sheets are reduced along the spine or bound edge resulting in reduced stress along the bound edge of each sheet. Another variable is the width of the reduced section along the bound edge. If this edge is two or three thicknesses of the original sheet, (˜30-mils) then the adhesion is increased and the stress on the joint is reduced, although the sheets tend not to lay flat. If the formatting is performed on a wider section, (120-mils) then the sheets are able to bend over a significantly larger area. The benefit is reduced stress along the spine joint and a significant advantage in the ability of the photo-book to lay flat when opened.

A further improvement of the formatted edge is to separate the two functions of improved adhesion surface area related to the thermal binding characteristics of the spine edge of the sheet and the increased flexibility of the thick sheet by reducing its cross section in the vicinity of the spine edge. Some applications may only require the formatting of the edge to improve the subsequent binding while others may require improved flexibility of the bound sheets and some may require both. Creating these features relates to the shape and position of the grinding wheel applied to one or both sides of the sheet during formatting and will be driven by the application and characteristics of the paper in question.

Conditioning, or formatting, the sheets by removing the material from one side of the paper edge creates a step on one side only. Sheets formatted in this manner would also create a gap between the sheets when gathered together to create a book block allowing the adhesive to migrate between the sheets during the thermal bookbinding process.

Another option is to format the edge of the sheet during the sheet fabrication process in which case the edge of the web would first be ground or abraded in a similar manner to the above described process.

Alternatively, two layers of thinner sheets could be laminated together allowing one edge of the sheets to overhang the edge of the other sheet to the desired width of the reduced section. Each layer of thinner paper, for example, might be 5-mils thick. When laminated together the end result would be similar to the single step configuration described above where the extended portion is 5-mils thick and the body of the paper is 10-mils thick.

The present invention thus provides paper sheets that are formatted on their edges in a manner such that the adhesive used in bookbinding systems provides an increased adhesion surface and reduces stress along the spine or bound edge of the resultant photo-book while increasing sheet flexibility.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a prior art system for forming a bound book;

FIG. 2 illustrates a prior art method for binding a book;

FIG. 3 illustrates the machine used to recondition the sheet edges in accordance with the teachings of the present invention;

FIG. 4 illustrates the formatted edge on both sides of a paper sheet;

FIG. 5 illustrates a book block of multiple sheets of the type shown in FIG. 4 ready for binding;

FIG. 6 illustrates a second embodiment of the present invention wherein material is removed from only one side of the sheet edge;

FIG. 7 illustrates a book block of multiple sheets formatted as shown in FIG. 6 ready for binding;

FIG. 8 illustrates the formatted edge on both sides of a paper sheet wherein the function of the improved adhesion geometry is separated from the enhanced flexible rendering geometry;

FIG. 9 illustrates a book block of multiple sheets of the type shown in FIG. 8 bound together with a soft cover;

FIG. 10 illustrates a formatted edge of a sheet with a tapered transition zone;

FIG. 11 illustrates a book block of multiple sheets depicted in FIG. 10 ready for binding;

FIG. 12 illustrates an edge formatted to only improve the adhesion qualities of a sheet;

FIG. 13 illustrates a formatted section to only improve the flexible qualities of a sheet;

FIG. 14 illustrates an edge formatted with a taper to only improve the adhesion qualities of a sheet;

FIGS. 15(a) and 15(b) illustrate the calculation of stress in a sheet of paper; and

FIG. 16 illustrates the conditioning of a sheet to reduce stress in the spine section.

### DESCRIPTION OF THE INVENTION

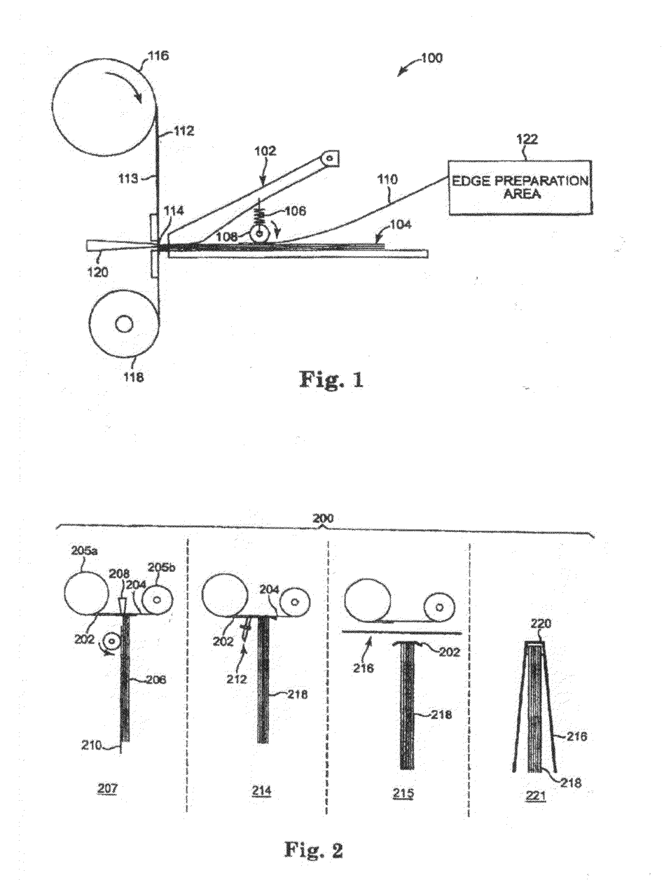

For the purposes of placing the present invention in perspective, a description of a prior art system for binding a plurality of sheets to form a book will be set forth. In this regard, FIG. 1 illustrates a system 100 for binding sheets (disclosed in U.S. Pat. No. 7,481,611 to Hoarau, issued Jan. 27, 2009). It is noted that the conditioned sheet of the present invention can be used with other binding systems.

The binding system 100 may be implemented as a desktop of office book making system designed to satisfy on-demand bookbinding needs.

The system 100 includes a clamp 102 for accumulating a plurality of sheets 104. Sheets 104 can enter the clamp 102 sheetwise; that is on an individual sheet-by-sheet basis. However, more than one sheet at a time may be accumulated in the clamp 102.

The clamp 102 includes a spring 106 and a roller 108. A newly added sheet 110 is transferred toward the adhesive by way of the roller 108. The spring 106 allows the distance between the jaws of the clamp 102 to be increased when a new sheet is added. For example, as a new sheet 110 is added, the spring is slightly compressed to accommodate for the newly added sheet.

To bind the plurality of sheets 104 together, an adhesive is applied. For example, an adhesive layer 112 is supported on a backing material 113 and is disposed adjacent an edge 114 of each of the plurality of sheets 104.

The backing material 113 allows the adhesive to be applied to the individual sheets, while protecting and preserving the side of the adhesive to be attached to the cover until the sheetwise binding operation is complete. In this way, the backing material 113 may be coated, so that it may be easily removed from the adhesive layer 112 when a cover is to be attached to the text body.

The adhesive layer 112 may be dispensed with a roller 116. When the adhesive layer 112 is dispensed by roller 116, a counter roller 118 collects unused backing material 113.

To attach the adhesive to the edges 114 of the plurality of sheets 104, the adhesive layer 112 is heated. A heater 120 is disposed on a side of the adhesive layer adjacent the backing material 113 to locally melt only a portion of the adhesive layer in a vicinity of a sheet 110 placed against the adhesive layer 112.

The system 100 typically includes an edge preparation area 122, in which each of the plurality of sheets 104 along the contacting surface is prepared prior to being placed adjacent the adhesive layer 112. In an exemplary embodiment, edge preparation area 122 includes devices for performing one or more of roughing, cutting, tearing, trimming, bending, folding and perforating of the sheets. Additional edge preparation devices and methods include devices for notch binding, in which notches are made on the contacting surface, e.g., edge or folded edge, by removing small sections to allow penetration of adhesive into individual sheets, and bursting binding in which large cuts made in the contacting surface of the sheet allow penetration of the adhesive material (note that in accordance with the teachings of the present invention, preparation area 122 is not necessary since the sheets utilized will already have a conditioned, or formatted, edge). Slits can also be made on the contacting surface with, for example, a toothed wheel, and milling the contacting surface with a grinder to produce rough edges. Fibers in the sheet exposed in these methods strengthen adhesion between the adhesive material and the sheet. Also, the area of the contacting surface exposed to the adhesive can be increased to thereby increase the binding strength.

The adhesive layer 112 including the backing material 113 is placed adjacent an edge 114 of the plurality of sheets 104. As each sheet 104 is placed in the clamp 102, the heater 120 can include a motor device to move the heating surface into a position to locally heat the adhesive layer 112 in a vicinity of that sheet.

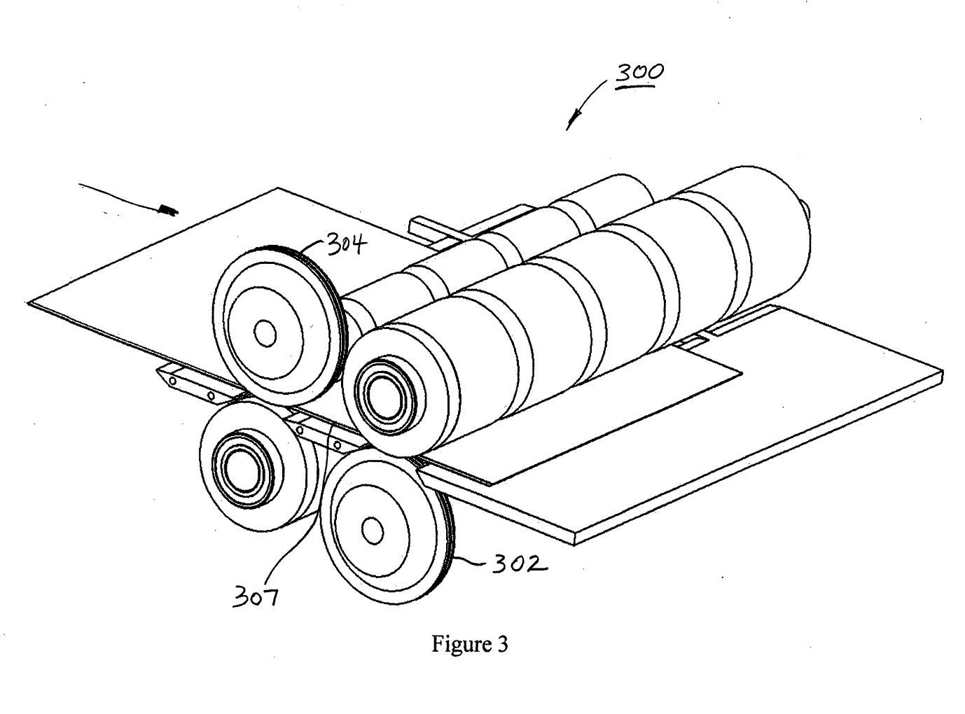

A prior art method 200 of sheetwise binding of pages is illustrated in FIG. 2 and comprises providing an adhesive layer 202 supported on a first side of a backing material 204. According to the method, the adhesive layer 202 and backing material 204 are dispensed by way of a roller 205a and the unused backing material 204 is collected by way of counter roller 205b. Typically adhesives include a thermal activated adhesive sold by H.B. Fuller Company (product number HL 3337) Saint Paul, Minn. under the trade name FULLBACK®.

Plural sheets 206 are accumulated against the adhesive layer 202 and applying heat locally to the adhesive layer 202 in an accumulating operation 207. A heater 208 is applied to a side of the adhesive layer 202 adjacent the backing material 204 to locally melt only a portion of the adhesive layer 202 in a vicinity of an additional sheet 210 accumulated against the adhesive layer 202.

Once the sheets 206 are accumulated against the adhesive layer 202 and the adhesive layer 202 and the plural sheets 206 are bound into a text body 218, the adhesive 202 may be cut by a cutter 212 in a cutting operation 214. Excess backing material 204 may then be removed by way of counter roller 205b.

In a subsequent operation 215, a cover 216 is applied over the text body 218 and against the exposed adhesive layer 202. The cover can be prepared to a selected spine width, such as a spine width corresponding to a dimension of the text body. The resulting bound document 220 includes the cover 216 adjacent the text body 218, as shown in operation 221.

Note that a number of other prior art document tape binding systems can utilize the formatted sheets described hereinabove including those disclosed in U.S. Pat. Nos. 5,829,938, 6,056,493 and 7,677,855.

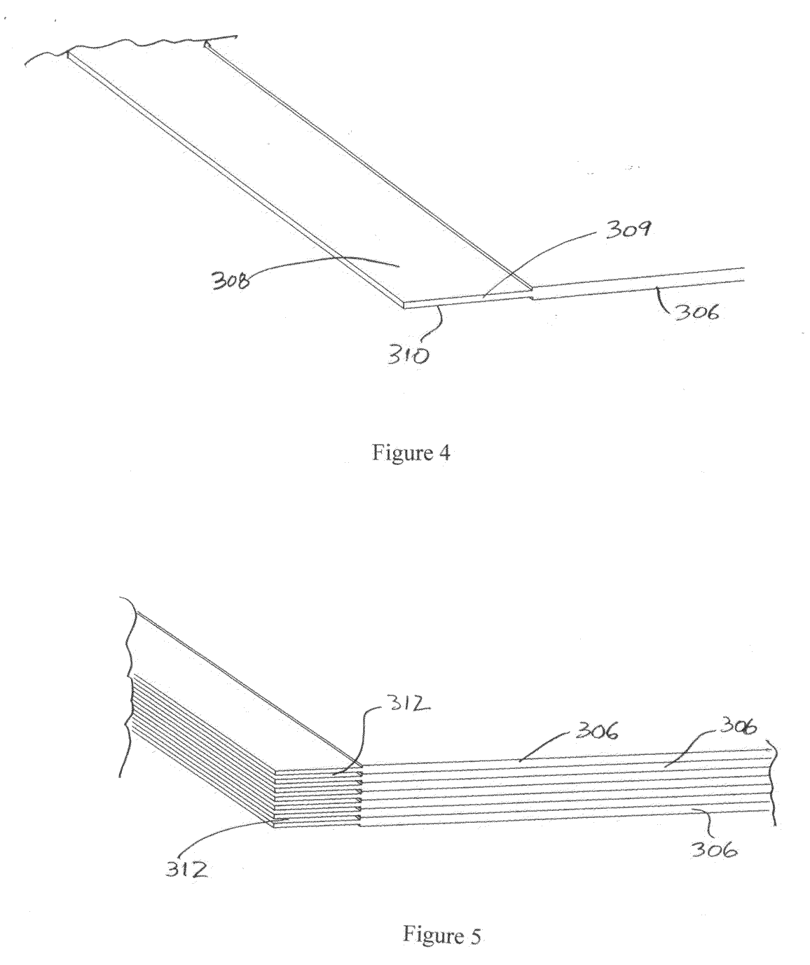

FIG. 3 illustrates conditioning apparatus 300 having grinding wheels 302 and 304 for cutting both edges of sheet 306 to provide formatted edge 307 in accordance with the teachings of the present invention. FIG. 4 illustrates the sheet 306 (preferably 12-point paper) after both surfaces are abraded to produce step 309 having edges 308 and 310. In accordance with teachings of the present invention, the width of the step is in the range between 80 and 120 mils and the thickness of step 309 is in the range between 3 mils and 8 mils.

FIG. 5 shows a plurality of sheets 306 formed in a book block ready for binding, the gaps 312 between sheets 306 allowing the adhesive used in the binding operation to penetrate the sheet fibers.

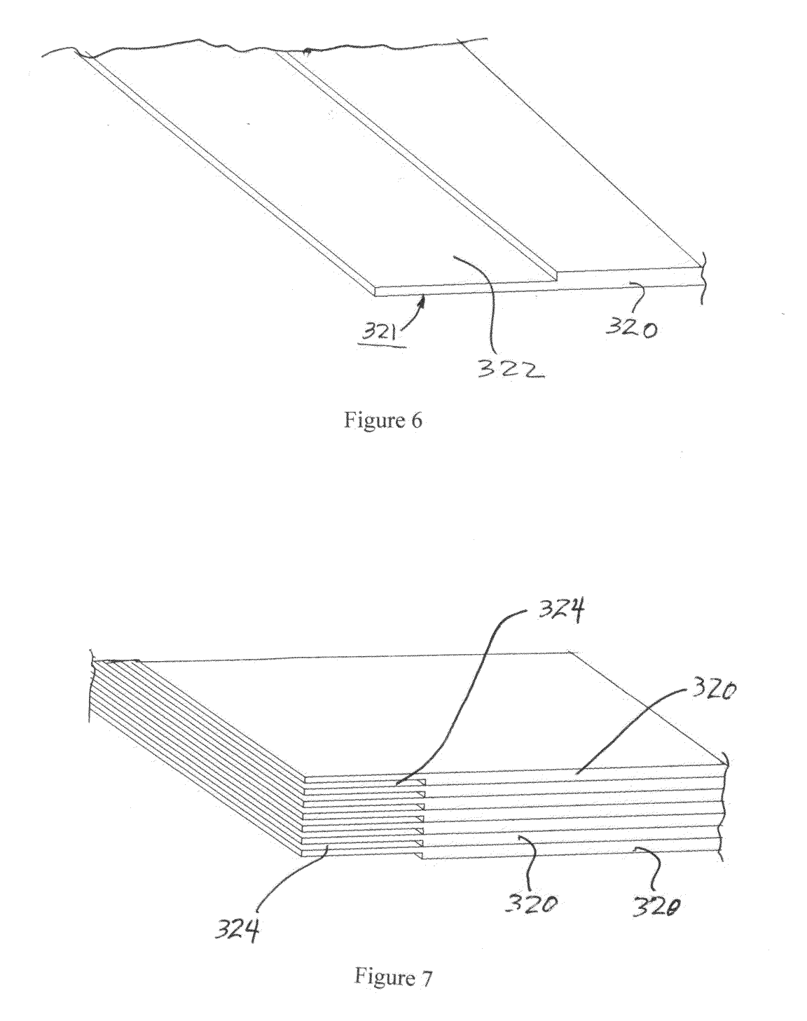

FIG. 6 shows a second embodiment of the present invention wherein the material is removed from sheet 320 in a manner creating a step 321 having a single surface 322 formed by an abrading step.

FIG. 7 illustrates a book block of sheets 320 ready for binding, the gaps 324 between sheets 320 allowing adhesive to migrate between the sheets during the thermal bookbinding process.

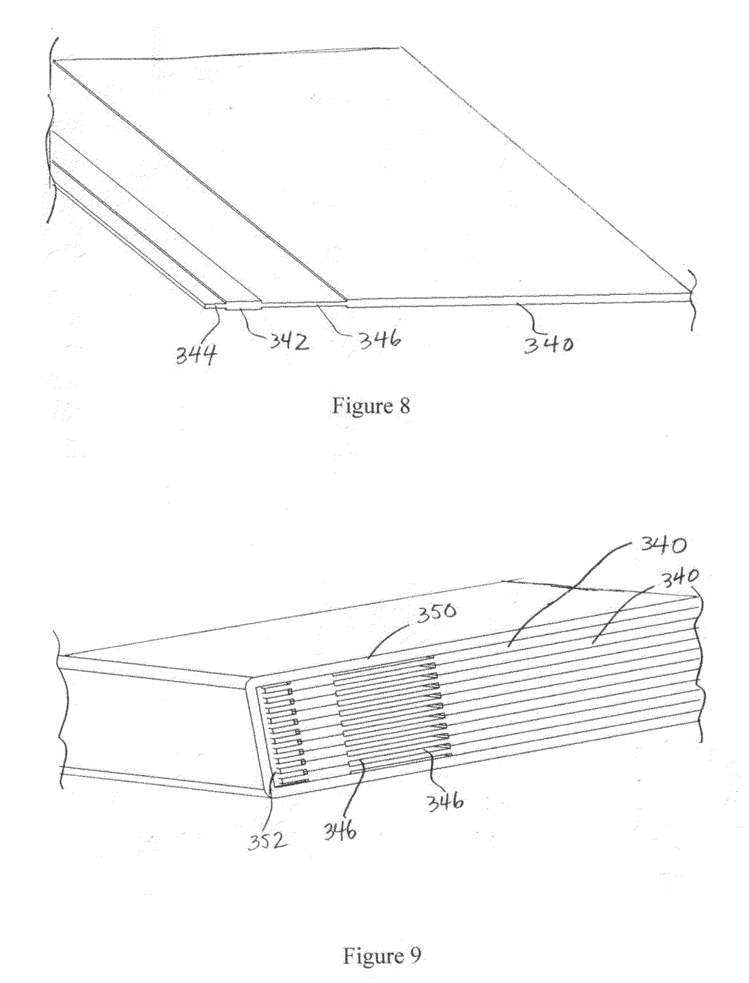

FIG. 8 shows a third embodiment of the present invention wherein the functions of enhancing the binding adhesion is separated from the function of the added flexibility of the sheet in the vicinity of the spine. A portion 342 of the sheet 340 separating the two sheet zones (344,346) retains the thickness of the sheet 340 (not thinned down) thereby blocking adhesive from flowing too far in between the sheets which can result in inconsistencies in the bind. Zone or hinge area 346 thus provides sheet flexibility after sheets 340 are formed in a book as shown in FIG. 9. This enables the book sheets to return to its original position after being bent or otherwise moved (i.e. after a user of the book, such as an album, flips the bound sheet for viewing and then releases the sheet).

The typical dimensions of sheet 340 are as follows:
Sheet 340 thickness: 12 mils
Section 346: thickness 4-6 mils, width 1/16″-¼″
Section 342: thickness 12 mils, width 20 mils-50 mils
Section 344: thickness 4-6 mils, width 20 mils-50 mils.

FIG. 9 illustrates a book block of sheets 340 bound with a soft cover 350; the gaps between the sheets 340 allowing adhesive 352 to migrate between the sheets 340 up to the barrier formed while not contaminating the hinge area, 346.

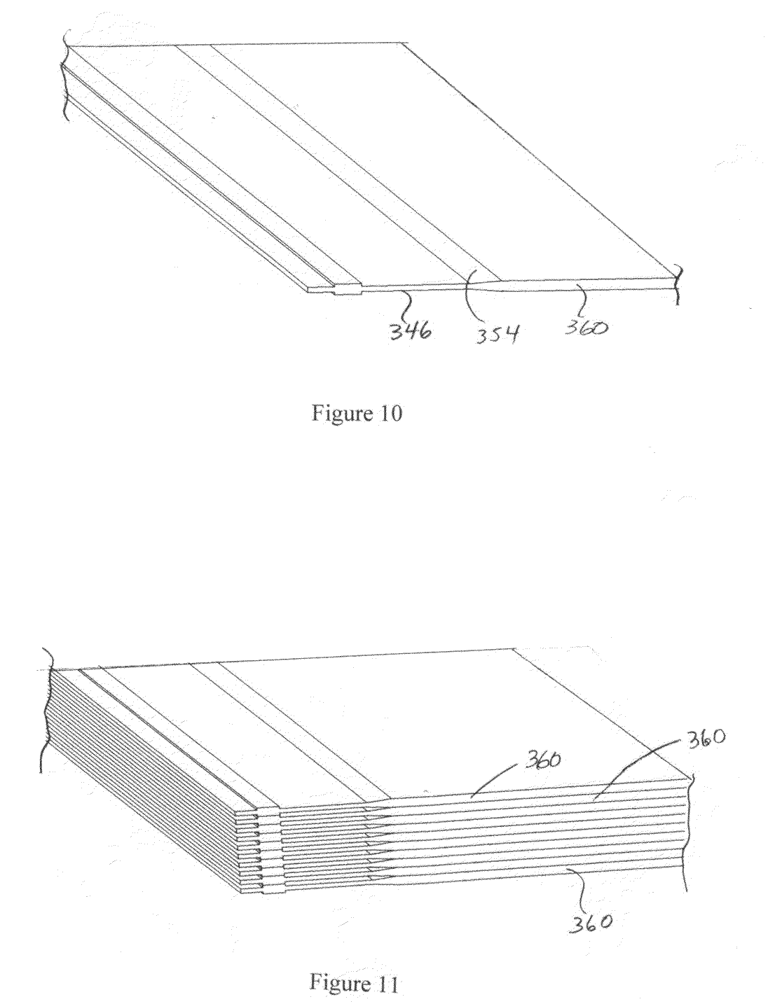

FIG. 10 shows a fourth embodiment of the present invention wherein the transition edge 354 from sheet 360 to the hinge area 346 is tapered.

For the stress in a sheet of paper being bent as the sheets, bound to the spine (similar to a beam being bent), the following provides an analysis of the forces involved.

Referring to FIGS. 15(a) and 15(b), stress(s) in a cantilever beam (beam supported on only one end) is equal to the bending moment (M) times the distance from the neutral axis to the outermost fiber (c) divided by the moment of inertia of the beam (I).

S=Mc/I; M=Fd; I=bh³/12

If the thickness of the paper (represented by the variable h) varies form 4-mils to 12-mils, the stiffness represented by the moment of inertia (I) will increase by 27 times, everything else being the same. The stress when the sheet of paper corresponding to a (beam) is attached to the spine by the adhesive (and assuming that the only variable to change is the thickness of the sheet of paper (h)):

S_{(4-mil paper)}=MC/I S=M(2)/(b)(4)³/12

S_{(12-mil paper)}=MC/I S=M(6)/(b)(12)³/12

Ratio=S_{(12-mil paper)}/S_{(4-mil paper)}=(2/4³)/(6/12³)=9

Thus, the stress in the sheet of paper at the point of contact with the binding adhesive is very affected by the thickness of the sheet of paper and is equal to the square of the difference in thickness. In the example above, the thickness varied by 3 times and the stress varied by 9 times. If the thickness varied from 4-mils to 8-mils, or 2 times, then the stress of the 8-mil sheet would be 4 times that of the thinner 4-mil sheet.

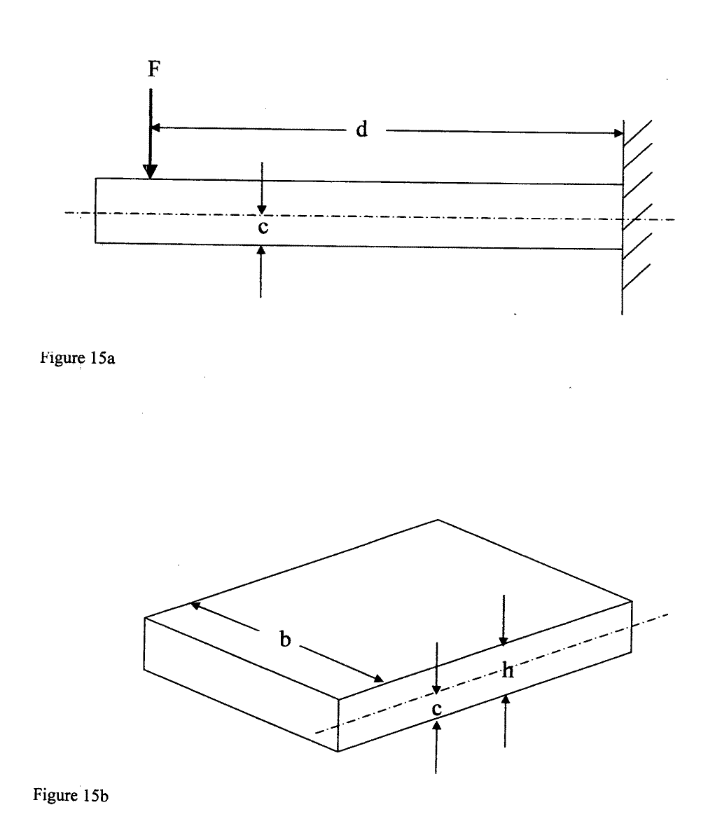

The stress induced by bending the sheet of the bound book is reduced, in accordance with the teachings of the present invention, by increasing the flexibility of the page close to the area where the sheet is attached to the back spine. Reducing the cross section of the sheet adjacent the spine 400 (providing a hinge area 402) allows the sheet 404 to bend in that area thereby reducing the stress in the spine section where the sheet is attached by means of the adhesive (See FIG. 16).

FIG. 11 illustrates a book block of sheets of the type illustrated in FIG. 10 ready for the application of thermal adhesive to bind the sheets 360 together.

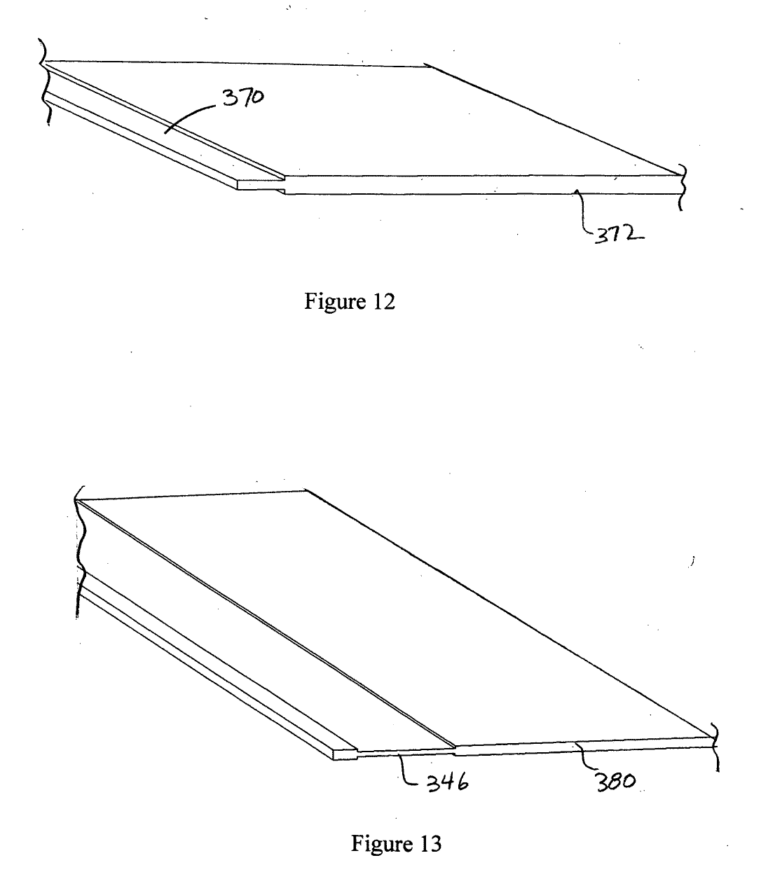

FIG. 12 illustrates the use of a narrow formatted section 370 in a double stepped paper sheet 372 which enables the adhesion properties of the sheet to increase. The width of section 370 is in the range between 10 and 30 mils.

FIG. 13 illustrates the use of the formatting process to enhance the flexibility of sheet 380 while not changing other characteristics of the sheet edge. In particular, the sheet zone 344 shown in FIG. 8 is not utilized, whereas the hinge zone 346 is retained.

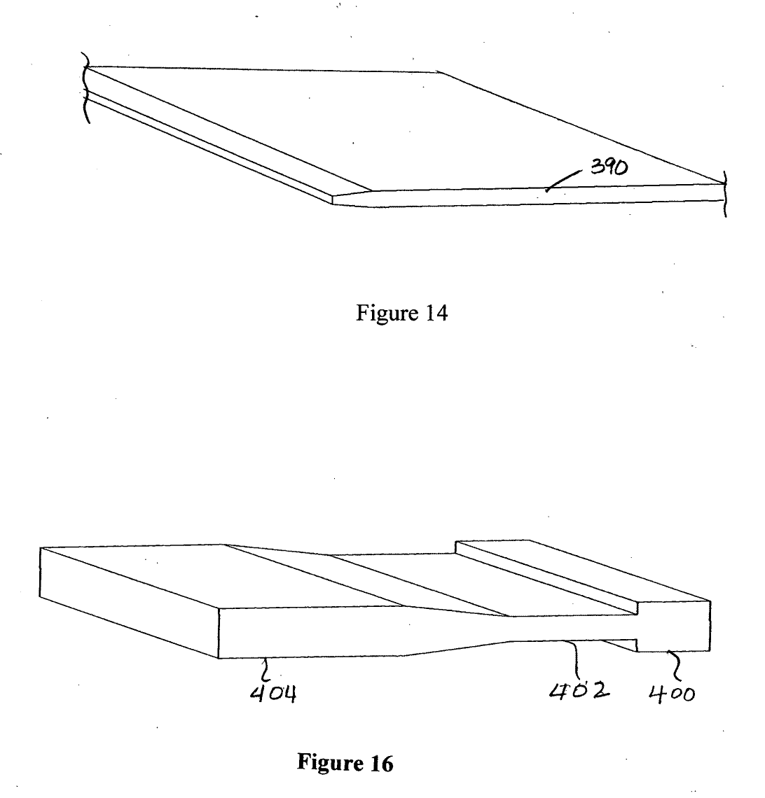

FIG. 14 is a further embodiment of the present invention whereby the surface area of the edge of sheet 390 is increased by beveling or tapering the corners of the sheet which improves the bonding strength of the thermally activated adhesive.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method of conditioning the edge of a paper sheet for subsequent binding comprising the steps of:
providing a sheet of paper having first and second surfaces and an edge on each surface, said first and second surfaces having coating material formed thereon;
placing said sheet of paper in a sheet edge formatting machine; and
operating said machine such that a first step portion is formed on the edge of said first surface.

2. The method of claim 1 wherein said first step portion has a width in the range between 100 and 200 mils and a depth in the range between 2 and 8 mils.

3. The method of claim 2 wherein said first step portion has a width of approximately 120 mils and a depth between 5 and 6 mils.

4. The method of claim 1 further including the step of forming a second step on the edge of said second surface opposite said first step portion.

5. The method of claim 4 wherein said second step portion has a width in the range between 100 and 200 mils.

6. The method of claim 1 wherein a plurality of said sheets are bound together to form a book.

7. The method of claim 4 wherein a plurality of said sheets are bound together to form a book.

8. The product produced by the method of claim 1.

9. The product produced by the method of claim 4.

10. A method of conditioning the edge of a paper sheet for subsequent binding comprising the steps of:
providing a sheet of paper having first and second surfaces and an edge on each surface, said first and second surfaces having coating material formed thereon;
placing said sheet of paper in a sheet edge formatting machine; and
operating said machine such that first and second step portions are formed at the edge of said sheet, said first and second step portions being separated from each other by a portion of said sheet.

11. The method of claim 10 wherein a plurality of said sheets are bound together to form a book.

12. The method of claim 11 wherein said second step portion forms an area that enables the bound sheets to be bent and thereafter return essentially to its original position.

13. The product formed by the process of claim 10.
